(19) United States
(12) Patent Application Publication
(10) Pub. No.: US 2003/0002248 A1
(43) Pub. Date: Jan. 2, 2003

(54) Electronic apparatus having pivotable rod-shaped radio communication antenna

(75) Inventors: Yuuji Nakaya, Ome-shi (JP); Masami Honda, Ome-shi (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA.

(21) Appl. No.: 10/136,787

(22) Filed: Apr. 29, 2002

(30) Foreign Application Priority Data
Jun. 29, 2001 (JP) 2001-200221

(51) Int. Cl. G06F 1/16; H04M 1/00

(52) U.S. Cl. 361/683; 455/557

(57) ABSTRACT

An electronic apparatus comprises a main body having a top surface provided with a display screen, a bottom surface, a front surface, a rear surface and right and left lateral surfaces. At least an operating member to be manually operated is arranged at a first lateral area of the main body. A rod-shaped antenna for radio communication is arranged at a second lateral area of the main body longitudinally separated from the first lateral area of the main body. The rod-shaped antenna is adapted to pivot between a first position where it is stored along the main body and a second position where it projects outward from the main body.

### CROSS-REFERENCE TO RELATED APPLICATIONS

This application is based upon and claims the benefit of priority from the prior Japanese Patent Application No. 2001-200221, filed Jun. 29, 2001, the entire contents of which are incorporated herein by reference.

### BACKGROUND OF THE INVENTION

1. Field of the Invention

This invention relates to an electronic apparatus having a rod-shaped radio communication antenna and an operating member such as a power supply switch. More particularly, the present invention relates to a structure for improving the operability of such a rod-shaped antenna and such an operating member.

2. Description of the Related Art

Electronic apparatuses such as PDAs (personal digital assistants) comprise a flat box-shaped main body. The main body has a top surface, a bottom surface, a front surface, a rear surface and left and right lateral surfaces. The main body contains a liquid crystal display and a printed wiring board. The liquid crystal display has a display screen for displaying information. The display screen is arranged on the top surface of the main body and exposed to the outside of the main body.

The main body is additionally provided with an operating member such as a power supply switch, and a card slot for receiving a PC card and a plurality of connectors. The operating member, the card slot and the connectors are allocated to the front surface, the rear surface and the lateral surfaces.

Electronic apparatuses available at present are provided with a radio communication feature such as a radio LAN. A plurality of electronic apparatuses having such a feature and located close to the user can be connected wirelessly to each other for mutually exchanging data. Electronic apparatuses having a radio communication feature are provided with a rod-shaped antenna. The rod-shaped antenna can be pivoted between a first position where it lies along the main body for storage and a second position where it projects from the main body.

Jpn. Pat. Appln. KOKAI Publication No. 10-150313 discloses an electronic apparatus provided with a rod-shaped antenna. In the disclosed apparatus, a display screen is arranged on the top surface of the main body. A rod-shaped antenna is arranged at the left end section of the rear surface of the main body so as to be able to pivot. A push-button type power supply switch is arranged at a left end part of the front surface of the main body.

When using the known electronic apparatus, the operator holds the left end part of the main body with his or her left hand and the right end part thereof with his or her right hand. Both the rod-shaped antenna and the power supply switch are arranged at the left end of the main body. Therefore, when the operator needs to operate the power supply switch while using the apparatus, he or she has to move the left hand toward a part of the front surface of the main body where he or she can touch the push-button type power supply switch. Similarly, when the operator needs to shift the direction of the rod-shaped antenna while using the apparatus, the operator has to move the left hand toward a part of the rear surface of the main body where he or she can touch the rod-shaped antenna.

Differently stated, since the left hand needs to be used for both the operation of pushing the power supply switch and that of shifting the direction of the rod-shaped antenna, the operator cannot do these two operations simultaneously. When the operator does these two operations, he or she needs to slide the left hand away along the left surface of the apparatus main body, holding the main body with the right hand, or switch to the right hand for holding the main body. Therefore, the sequence of operation is discontinued. The operator cannot continuously perform the operation of pushing the power supply switch and that of shifting the direction of the rod-shaped antenna.

Furthermore, when the operator operates the power supply switch and the rod-shaped antenna, his or her right hand simply holds the main body and does not participate in the operation of pushing the power supply switch nor that of moving the rod-shaped antenna. In short, the rod-shaped antenna and the power supply switch of such known electronic apparatuses are not arranged with due consideration given to their operability. Thus, they are far from satisfactory in terms of operability.

### BRIEF SUMMARY OF THE INVENTION

In view of the above identified circumstances, embodiments of the present invention provide an electronic apparatus having a rod-shaped antenna and an operating member that are highly operable and can be used with ease.

Additional advantages of embodiments of the invention will be set forth in the description which follows, and in part will be obvious from the description, or may be learned by practice of embodiments of the invention. The advantages of embodiments of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a schematic plan view of an embodiment of a portable electronic apparatus according to the invention;

FIG. 1B is a schematic left lateral view of the embodiment of the portable electronic apparatus;

FIG. 1C is a schematic right lateral view of the embodiment of the portable electronic apparatus;

FIG. 1D is a schematic rear view of the embodiment of the portable electronic apparatus;

FIG. 2 is a schematic plan view of the embodiment of the portable electronic apparatus with the rod-shaped antenna pivoted to a second position;

FIG. 3 is an enlarged schematic perspective partial view of the embodiment of the portable electronic apparatus, illustrating its fingerprint detecting section;

FIG. 4 is a schematic perspective view of the embodiment of the portable electronic apparatus with the rod-shaped antenna pivoted to a second position;

FIG. 5 is a schematic perspective view of the embodiment of the portable electronic apparatus with the rod-shaped antenna pivoted to a first position;

FIG. 6 is a schematic plan view of the embodiment of the portable electronic apparatus, illustrating the cover and the main body in a state where they are separated from each other;

FIG. 7A is a schematic plan view of the cover for covering the main body;

FIG. 7B is a schematic left lateral view of the embodiment of the portable electronic apparatus, illustrating the cover and the main body in a state where they are combined;

FIG. 8 is a schematic plan view of the embodiment of the portable electronic apparatus, illustrating the display/input screen of the main body exposed by unfolding the cover;

FIG. 9 is a schematic perspective view of the embodiment of the portable electronic apparatus, illustrating the display/input screen of the main body exposed by unfolding the cover;

FIG. 10 is a schematic perspective view of the embodiment of the portable electronic apparatus, illustrating the cover strap and the second cover section in state where they are unlinked from each other;

FIG. 11 is a schematic perspective view of the embodiment of the portable electronic apparatus in a state where the main body is completely covered by the cover; and

FIG. 12 is a schematic perspective view of the embodiment of the portable electronic apparatus in a state where the main body is held by hands for operation.

### DETAILED DESCRIPTION OF THE INVENTION

Now, the present invention will be described by referring to the accompanying drawings obtained by applying embodiments of the invention to a PDA (personal digital assistant) as a non-limiting example.

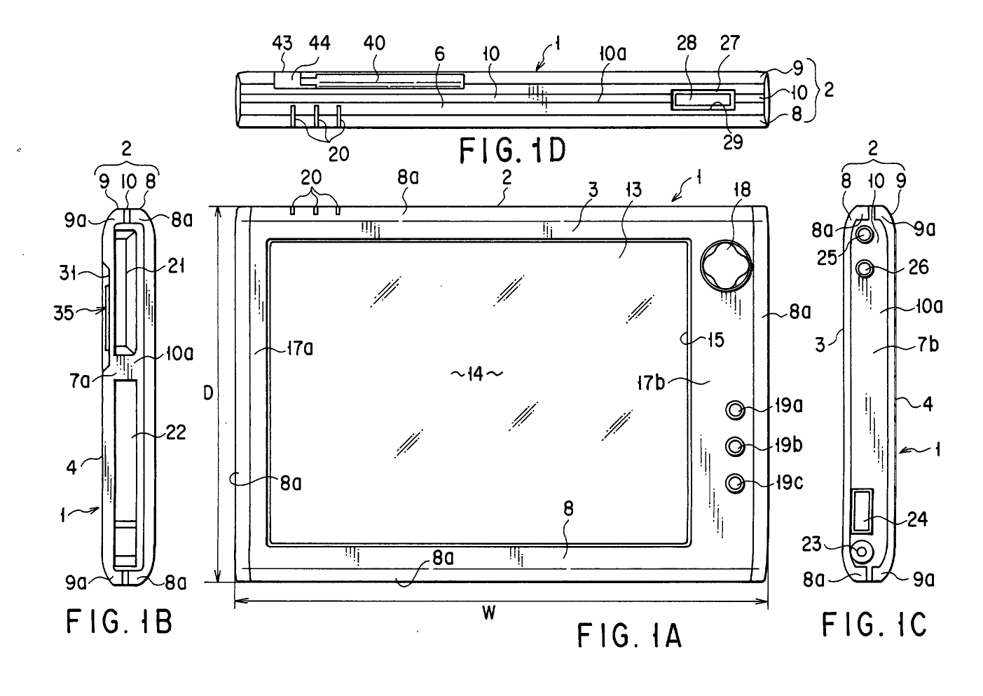

FIGS. 1A through 1D are schematic views of the embodiment of electronic apparatus 1, which is a PDA comprising a pen type input. The electronic apparatus 1 has a radio communication feature, which may be a radio LAN feature. The electronic apparatus 1 comprises a main body 2 made of synthetic resin. The main body 2 has a flat box-shaped profile and its width W is greater than its depth D. The main body 2 has a top surface 3, a bottom surface 4, a front surface 5, a rear surface 6 and left and right lateral surfaces 7a and 7b. The top surface 3 and the bottom surface 4 are substantially rectangular. The front surface 5 and the rear surface 6 are stripe-shaped and extend to define the width of the main body 2. The lateral surfaces 7a and 7b are stripe-shaped and extend to define the depth of the main body 2.

The main body 2 comprises an upper case 8, a lower case 9 and a frame 10. The upper case 8 defines the top surface 3 of the main body 2. The upper case 8 has an outer peripheral edge section 8a surrounding the top surface 3 along the four sides thereof. The outer peripheral edge section 8a extends downward from the top surface 3. The lower case 9 defines the bottom surface 4 of the main body 2. The lower case 9 has an outer peripheral edge section 9a surrounding the bottom surface 4 along the four sides thereof. The outer peripheral section 9a extends upward from the bottom surface 4. The upper case 8 and the lower case 9 are disposed oppositely relative to each other in the direction of the height H of the main body 2. The frame 10 is interposed between the upper case 8 and the lower case 9. The frame 10 has four outer peripheral wall sections 10a. The top ends of the outer peripheral wall sections 10a abut the outer peripheral edge section 8a of the upper case 8. The bottom ends of the outer peripheral wall sections 10a abut the outer peripheral edge section 9a of the lower case 9. Thus, the front surface 5, the rear surface 6 and the left and right lateral surfaces 7a and 7b of the main body 2 are formed by the outer peripheral edge section 8a of the upper case 8, the outer peripheral edge section 9a of the lower case 9 and the outer peripheral wall sections 10a of the frame 10.

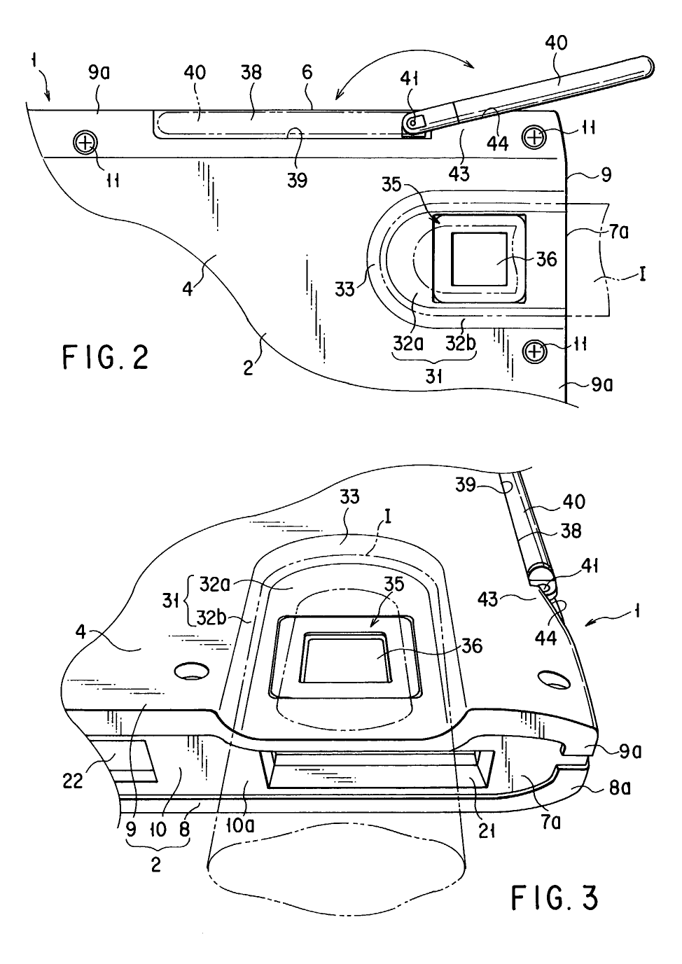

As best shown in FIGS. 2 and 3, the upper case 8, the lower case 9 and the frame 10 are linked to each other by means of a plurality of screws 11. The screws 11 are driven into the upper case 8 through the lower case 9 and the frame 10. Thus, the frame 10 is pinched between the upper case 8 and the lower case 9.

The main body 2 contains a liquid crystal display (not shown) and a printed wiring board (not shown). The liquid crystal display and the printed wiring board are contained in a space defined by the outer peripheral wall sections 10a of the frame 10. Referring again to FIG. 1A, a tablet 13 is laid on the liquid crystal display. The tablet 13 has an input/display screen 14. The screen 14 is exposed to the outside of the main body 2 by way of an aperture 15 formed at the top surface 3. A plurality of icons (not shown) is arranged on the screen 14. As one of the icons is touched by a stylus pen 16 (as shown in FIG. 10), an information input session begins and then an operation selected from a menu is started.

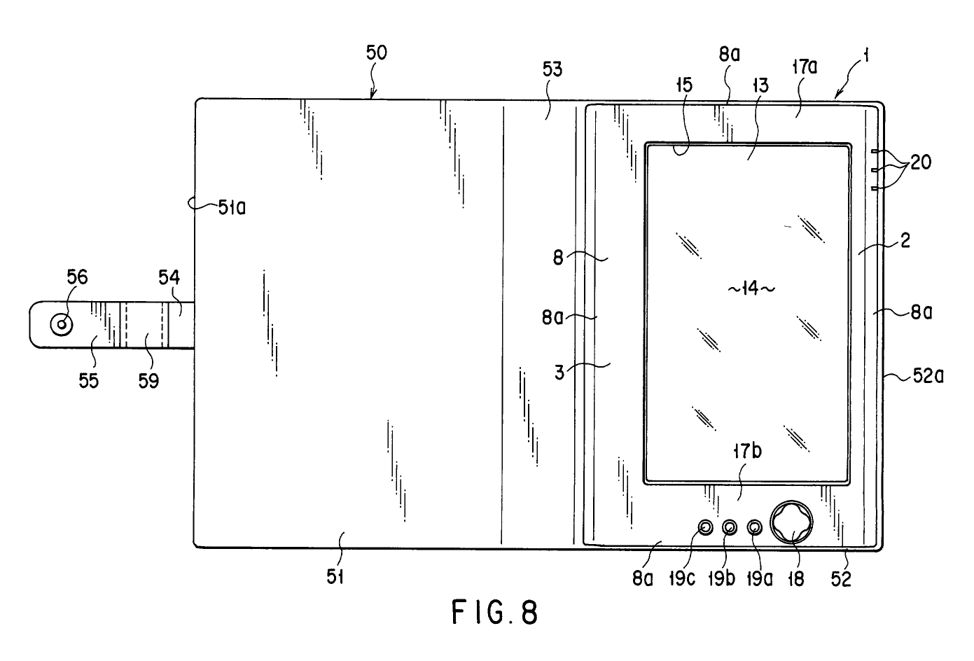

As shown in FIG. 1A and FIG. 8, the screen 14 has dimensions substantially equal to those of the top surface 3 of the main body 2. The top surface 3 of the main body 2 includes a pair of thumb receiving sections 17a and 17b. Thumb receiving section 17a is arranged to the left of the screen 14. Thumb receiving section 17b is arranged to the right of the screen 14. Thus, the thumb receiving sections 17a and 17b are separated from each other in a longitudinal direction (i.e., the direction of the width W)of the main body 2 with the screen 14 interposed between them.

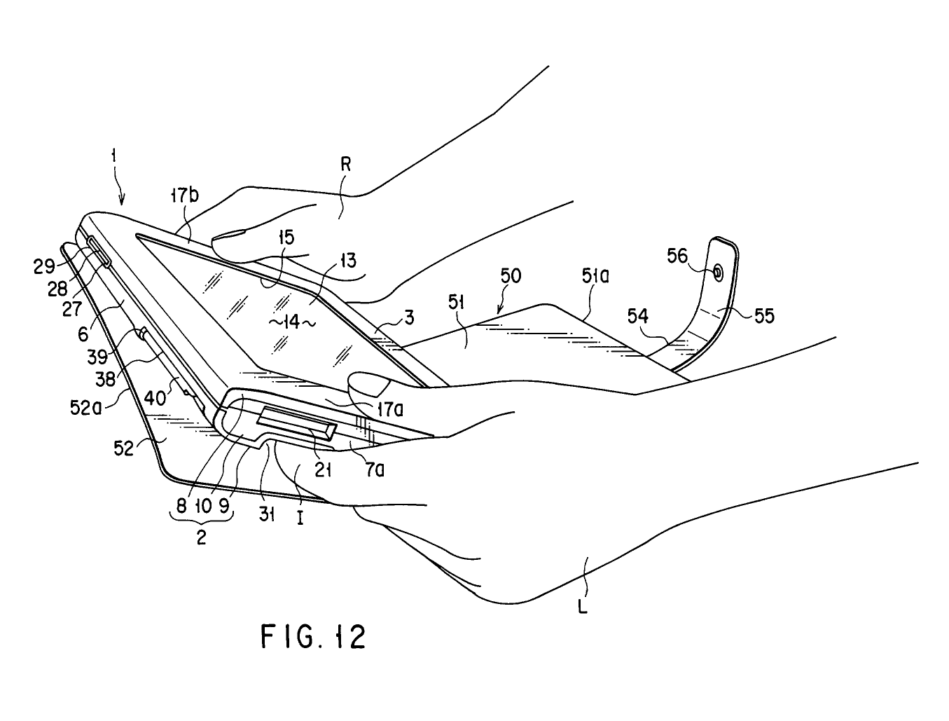

As shown in FIG. 12, the electronic apparatus 1 is operated by the operator who holds the main body 2 with the left hand L and the right hand R. The thumb of the left hand L touches the thumb receiving section 17a of the top surface 3, while the thumb of the right hand R touches the thumb receiving section 17b of the top surface 3. In other words, the thumb receiving sections 17a and 17b are areas for receiving the respective thumbs when the operator is using the electronic apparatus 1.

As shown in FIG. 1A, the thumb receiving section 17b has a dimension greater than the thumb receiving section 17a in the longitudinal direction of the main body 2. A cursor key 18 and first through third operation buttons 19a, 19b, and 19c are arranged in the thumb receiving section 17b. The cursor key 18 is used to operate the cursor in the screen 14. The first through third operation buttons 19a, 19b and 19c are used to start respectively an Internet browser, mail software and an application program. The cursor key 18 and the first through third operation buttons 19a, 19b and 19c are arranged in a row running in the direction of the depth of the main body 2.

The main body 2 is further provided with a plurality of indicator lamps 20. The indicator lamps 20 are used to show the operation status of the apparatus 1. The indicator lamps 20 are arranged along the edges defined by the top surface 3 and the rear surface 6 of the main body 2 and are biased to the left side of the top surface 3 and the rear surface 6 relative to the midpoints of those surfaces in the longitudinal direction of the main body 2. Gaps separate the indicator lamps 20 from each other in the longitudinal direction.

As shown in FIGS. 1B, 1C and 1D, the main body 2 comprises a first card slot 21, a second card slot 22, a power source connector socket 23, a USB connector socket 24, a headphone output jack 25, a microphone input jack 26 and a power supply switch 27 which is an operating member.

The first card slot 21 is used for receiving a memory card into and ejecting it from the main body 2. The second card slot 22 is used for receiving a PC card into and ejecting it from the main body 2. The first and second card slots 21, 22 are open and formed side by side at the left lateral surface 7a of the main body 2. The power source connector socket 23 and the USB connector socket 24 are arranged side by side at the right lateral surface 7b of the main body 2. Similarly, the headphone output jack 25 and the microphone input jack 26 are arranged side by side at the right lateral surface 7b of the main body 2.

The power supply switch 27 has a push button 28. The push button 28 is operated manually by means of the right hand of the operator. The power supply switch 27 is turned on and off as the push button 28 is depressed by a finger tip. The push button 28 is located in a right end section of the rear surface 6 of the main body 2 that is arranged adjacent to the right lateral surface 7b of the main body 2. Thus, the push button 28 is located in a longitudinally lateral area of the main body 2.

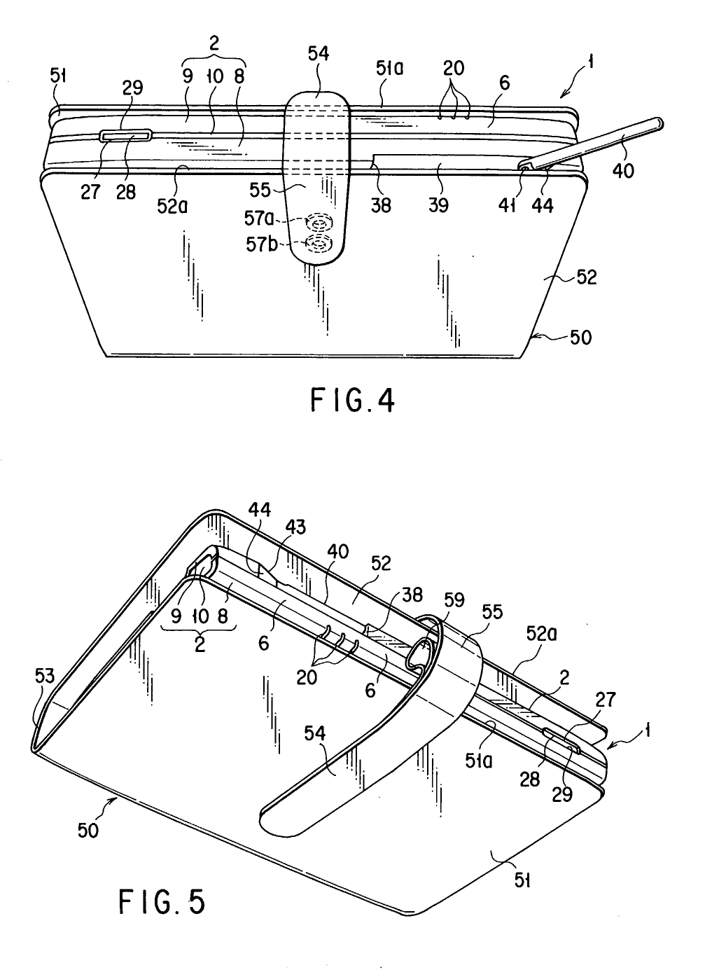

As shown in FIG. 1D and FIG. 4, the main body 2 has a recess 29 on the rear surface 6 thereof. The recess 29 is formed in one of the outer peripheral wall sections 10a of the frame 10. The push button 28 of the power supply switch 27 is arranged in the inside of the recess 29. In other words, while the push button 28 is exposed at the rear surface 6 of the main body 2, it does not project from the rear surface 6. Thus, the push button 28 is protected against operation errors. At the same time, when the apparatus 1 is carried in a bag, the apparatus 1 is protected against operation errors that can otherwise occur when the push button 28 is inadvertently touched and pushed by some other object.

The position of the power supply switch 27 is not limited to the rear surface 6 of the main body 2. Since the power supply switch 27 is only required to be operated with the right hand of the operator holding the main body 2, the power supply switch 27 may alternatively be arranged, for example, in the thumb receiving section 17b arranged at the right side of the main body 2.

As shown in FIGS. 2 and 3, the bottom surface 4 of the main body 2 is provided with a cavity 31. The cavity 31 is so sized as to snuggly receive the index finger I of the left hand L. The cavity 31 is located in a left end section of the main body 2 that is adjacent to the rear surface 6 of the main body 2. The cavity 31 is open at the lower surface 4 and the left lateral surface 7a of the main body 2.

Additionally, the cavity 31 has a flat bottom surface 32a and a peripheral surface 32b extending between the bottom surface 32a and the bottom surface 4 of the main body 2. The bottom surface 32a is designed to receive the finger tip of the left index finger I and arranged in parallel with the bottom surface 4 of the main body 2. The peripheral surface 32b surrounds the bottom surface 32a. The peripheral surface 32b includes an end section 33 located remotest from the left lateral surface 7a of main body 2. The end section 33 is curved in the form of a sector so that it may snugly touch the finger tip of the left index finger I.

A fingerprint detection sensor 35 is arranged in a central area of the bottom surface 32a of the cavity 31. The fingerprint detection sensor 35 is designed to optically detect the fingerprint of the finger tip of the index finger I. The fingerprint detection sensor 35 comprises a light emitting section, a light receiving section (both not shown) and a transparent guide plate 36 supported by the bottom surface 32a. The light emitting section and the light receiving section are contained in the inside of the main body 2. The guide plate 36 is adapted to be pressed by the finger tip of the index finger I and exposed in the cavity 31. Light emitted from the light emitting section is irradiated onto the finger tip pressed against guide plate 36. Light reflected by the guide plate 36 is led to the light receiving section. The light receiving section optically detects the finger print of the finger tip as it receives light and transmits a signal representing the finger print to a collating section mounted on said printed wiring board. The collating section stores the finger print of the index finger I of the operator of the apparatus 1 that is registered there in advance. Therefore, the collating section collates the registered finger print and the finger print detected by the finger print detection sensor 35 and, if they agree with each other, it transmits a control signal to a control section arranged on the printed wiring board. Upon receiving the control signal, the control section controls the electronic apparatus 1 so as to bring it into a standby state.

As shown in FIG. 12, when using the apparatus 1, the operator grasps the main body 2, pinching a left end portion of the main body 2 between the thumb and the fingers of the left hand L. Thus, the index finger I of the left hand L comes under the main body 2 and the front end of the index finger I touches the bottom surface 4 of the main body 2 at a position close to the rear surface 6 of the main body 2. The cavity 31 provided with the guide plate 36 is located adjacent to the rear surface 6 of the main body 2. Therefore, the front end of the index finger I is inevitably guided into the cavity 31. Thus, the operator can put the index finger I of the left hand L into the cavity 31 without looking at the bottom surface 4 of the main body 2.

As the finger tip of the index finger I of the left hand L is put into the cavity 31, the front end of the finger tip abuts the front end of the peripheral surface 32b of the cavity 31. As a result, the index finger I is placed in the correct position in the cavity 31 and the central portion of the finger tip that carries the finger print is located exactly on the guide plate 36. Thus, the index finger I can be aligned with the finger print detection sensor 35 with ease and the finger print can be detected accurately.

As shown in FIGS. 2 and 4, the main body 2 of the apparatus 1 is provided with an antenna containing section 38. The antenna containing section 38 has a groove 39 extending straight in the longitudinal direction of the main body 2. The groove 39 extends along the edge defined by the bottom surface 4 and the rear surface 6 of the main body 2. The groove 39 is biased leftward from the midpoint of the width (i.e. the longitudinal direction) of the main body 2 and located adjacent to the left lateral surface 7b of the main body 2.

A rod-shaped antenna 40 is arranged in the antenna containing section 38. The rod-shaped antenna 40 is used to transmit data from the electronic apparatus 1 to some other apparatus and receive data from some other apparatus. The rod-shaped antenna 40 is electrically connected to the printed wiring board of the main body 2. The rod-shaped antenna 40 is supported at the left end of the antenna containing section 38 by way of a pivot 41. The pivot 41 is arranged along the standing direction of the main body 2. The rod-shaped antenna 40, is biased leftward from the midpoint of the width of the main body 2 and is arranged longitudinally near the left lateral side of the main body 2. In other words, the rod-shaped antenna 40 and the power supply switch 27 are located on lateral areas of the main body 2 longitudinally separated from each other.

The rod-shaped antenna 40 can be pivoted between a first position and a second position. FIG. 5 schematically illustrates the rod-shaped antenna 40 pivoted to the first position. In this first position, the rod-shaped antenna 40 is contained in the groove 39 of the antenna containing section 38 and lies along the rear surface 6 of the main body 2. FIGS. 2 and 4 schematically illustrate the rod-shaped antenna 40 pivoted to the second position. In this second position, the rod-shaped antenna 40 projects outward from the main body 2. Thus, the rod-shaped antenna 40 is manually pivoted toward the second position by the operator for radio communication.

As shown in FIGS. 2 and 10, the antenna containing section 38 is provided with a stopper 43. The stopper 43 is provided to define the largest standing angle of the rod-shaped antenna 40. The stopper 43 is located at the left end of the antenna containing section 38 just adjacent to the corresponding end of the rod-shaped antenna 40. The stopper 43 has a stopper surface 44 for contacting the rod-shaped antenna 40. The stopper surface 44 extends from the left end of the antenna containing section 38 toward the rear surface 6 of the main body 2. More specifically, the stopper surface 44 is inclined to come closer to the rear surface 6 of the main body 2 as it proceeds from the left end of the antenna containing section 38 toward the left lateral surface 7a of the main body 2.

As shown in FIG. 2, when the rod-shaped antenna 40 is pivoted from the first position toward the second position, the rod-shaped antenna 40 abuts the stopper surface 44 before it is pivoted by an angle of 180°. With this arrangement, the rod-shaped antenna 40 is prevented from being inclined excessively and held to a state where it is projecting outward from the main body 2.

The stopper surface 44 is inclined toward the rear surface 6 of the main body 2. Therefore, the stopper surface 44 is made oblong along the axial direction of the rod-shaped antenna 40 to increase the contact area of the rod-shaped antenna 40 and the stopper surface 44. As a result, the stopper surface 44 can reliably support the rod-shaped antenna 40 and the rod-shaped antenna 40 can maintain its posture on a stable basis.

As shown in FIGS. 4 through 9, the electronic apparatus 1 is provided with a cover 50 for removably covering the main body 2. The cover 50 protects the main body 2 and increases the portability of the main body 2 at the same time. The cover 50 comprises a first cover section 51, a second cover section 52, a third cover section 53 and a strap 54.

The first cover section 51 is adapted to cover the top surface 3 of the main body 2. The first cover section 51 has a rectangular profile with its width and its depth respectively slightly greater than the width and the depth of the top surface 3. The second cover section 52 is adapted to cover the bottom surface 4. The second cover section 52 has a rectangular profile with its width and its depth respectively slightly greater than the width and the depth of the bottom surface 4. The third cover section 53 is adapted to cover the front surface 5. It is stripe-shaped and extends along the front surface 5. The third cover section 53 is arranged between the first cover section 51 and the second cover section 52 and links the first and second cover sections 51 and 52.

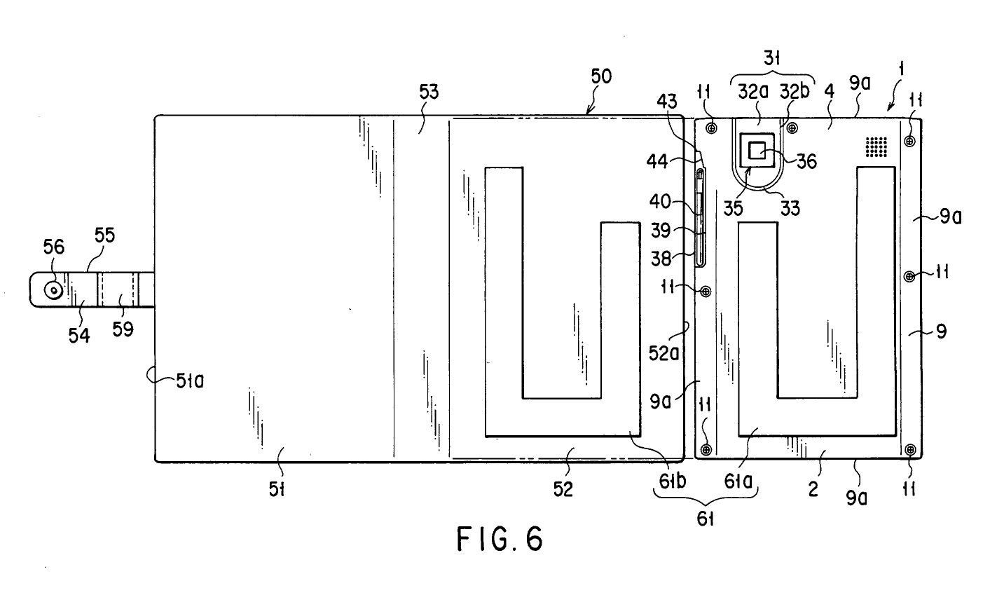

The first through third cover sections 51, 52 and 53 are integrally formed and their outer coat members are made of a soft material such as leather. The outer coat member of the first cover section 51 and that of the second cover section 52 are reinforced by respective rigid core members. As a result, the first and second cover sections 51 and 52 are hard and can maintain their proper flatness. The outer coat member of the third cover section 53 is not reinforced by a core member and hence is soft. Therefore, the cover 50 can be folded at the part corresponding to the third cover section 53. In other words, the cover 50 is resiliently deformable between a first state where they are unfolded and extended so as to align the first through third covers 51, 52 and 53 as shown in FIG. 6 and a second state where they are folded to make the first cover section 51 and the second cover section 52 face each other as shown in FIGS. 4, 5 and 7B.

The first cover section 51 has an edge 51a extending longitudinally along the main body 2. Similarly, the second cover section 52 has an edge 52a extending longitudinally along the main body 2. The edges 51a and 52a come to face each other when the cover 50 is folded and extend along the rear surface 6 of the main body 2. Furthermore, the edges 51a and 52a extend outwardly from the main body 2 beyond the rear surface 6. The rod-shaped antenna 40 arranged at the rear surface 6 is located between the edges 51a and 52a. When the rod-shaped antenna 40 is pivoted to the second position, it projects beyond the edge 51a of the first cover section 51 and the edge 52a of the second cover section 52.

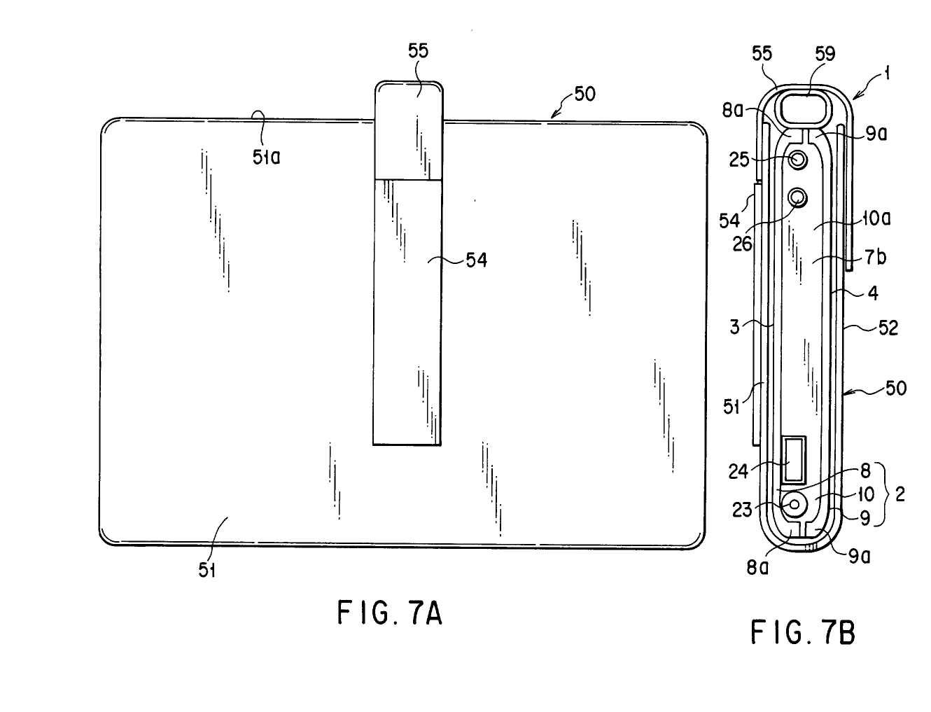

As shown in FIGS. 4 through 6, said strap 54 is oblong and strip-shaped. The strap 54 is secured to a central area of the outer surface of the first cover section 51 by sewing. When the cover 50 is unfolded and extended, the strap 54 is located at a position opposite to the third cover section 53. The strap 54 has an extending section 55 that extends from the edge 51a of the first cover section 51. As shown in FIG. 7B, the extending section 55 of the strap 54 has such a length that the front end of the strap 54 reaches the outer surface of the second cover section 52 when the cover 50 is folded. Thus, the strap 54 bridges the first cover section 51 and the second cover section 52 at the side opposite to the third cover section 53 with the main body 2 interposed between them.

As shown in FIG. 10, a stud 56 is fitted to a front end area of the extending section 55 of the strap 54. The stud 56 comes to face the outer surface of the second cover section 52 when the front end of the extending section 55 is lead to the second cover section 52. Furthermore, first and second sockets 57a, 57b are fitted to the outer surface of the second cover section 52. The first and second sockets 57a, 57b can be removably fastened to the stud 56 and are arranged along the direction defining the depth of the apparatus 1 with a gap separating them from each other. The first socket 57a is located closer to the edge 52a of the second cover section 52 than the second socket 57b. Thus, the strap 54 bridges the first cover section 51 and the second cover section 52 as the stud 56 is fastened either to the first socket 57a or to the second socket 57b. As a result, the first cover section 51 and the second cover section 52 are held oppositely with the main body 2 interposed between them to make the cover 50 totally cover the main body 2 so that the main body 2 may be carried conveniently.

As shown in FIGS. 4 and 5, the strap 54 bridges the first cover section 51 and the second cover section 52 at a middle position in the longitudinal direction of the main body 2. In other words, the strap 54 bridges the first cover section 51 and the second cover section 52 at a position off the rod-shaped antenna 40. Thus, the strap 54 and the rod-shaped antenna 40 do not interfere with each other and hence the strap 54 would never obstruct the pivoting motion of the rod-shaped antenna 40. Therefore, when the strap 54 bridges the first cover section 51 and the second cover section 52, rod-shaped antenna 40 can be pivoted from the first position to the second position and vice versa.

As shown in FIGS. 10 and 11, a ring-shaped pen holder 59 is fitted to the extending section 55 of the strap 54. The pen holder 59 is designed to removably hold the stylus pen 16. When the strap 54 bridges the first cover section 51 and the second cover section 52, the pen holder 59 is located between the extending section 55 of the strap 54 and the rear surface 6 of the main body 2. Thus, the stylus pen 16 is held to the cover 50 along the rear surface 6 of the main body 2.

More specifically, when the stylus pen 16 held to the pen holder 59, it is located between the strap 54 and the rear surface 6 of the main body 2. Then, the extending section 55 of the strap 54 is moved away from the rear surface 6 by a distance corresponding to the diameter of the stylus pen 16. Thus, when the stylus pen 16 is held to the pen holder 59, the stud 56 of the strap 54 is fastened to the first socket 57a that is closer to the edge 52a of the second cover section 52. On the other hand, when the stylus pen 16 is pulled out of the pen holder 59, it is no longer necessary to secure a space for containing the stylus pen 16 between the extending section 55 of the strap 54 and the rear surface 6 of the main body 2. Therefore, the stud 56 of the strap 54 is fastened to the second socket 57b that is more remote from the edge 52a of the second cover section 52.

As shown in FIG. 6, the cover 50 is removably held to the main body 2 by means of a surface fastener 61. The surface fastener 61 comprises a hook tape 61a carrying a large number of hooks and a loop tape 61b carrying a large number of loops. The tapes 61a, and 61b are separably laid one on the other.

The hook tape 61a is bonded to the bottom surface 4 of the main body 2. The hook tape 61a is arranged in an outer peripheral region of the bottom surface 4 located off the cavity 31 having the finger print detection sensor 35. The loop tape 61b is bonded to the inner surface of the second cover section 52 of the cover 50. The loop tape 61b is arranged in a region located along the outer peripheral edge of the second cover section 52. Thus, the main body 2 and the cover 50 are linked to each other as the main body 2 is laid on the second cover section 52 with the hook tape 61a located vis-à-vis the loop tape 61b.

Since the hook tape 61a is arranged in a region located off the cavity 31, the surface fastener 61 is not found between the left edge of the bottom surface 4 of the main body 2 and the second cover section 52. Therefore, the part of the second cover section 52 that covers the cavity 31 is held to a state where it can be deformed to move away from the bottom surface 4 of the main body 2. Thus, as shown in FIG. 12, the operator can put the index finger I of the left hand L into the gap between the bottom surface 4 of the main body 2 and the second cover section 52, while grasping a left end portion of the main body 2 with the left hand L. Then, the index finger I of the left hand L can be easily led into the cavity 31 so that the finger print can be collated without removing the cover 50 from the main body 2.

Now, the sequence of operation of driving the electronic apparatus 1 will be discussed below.

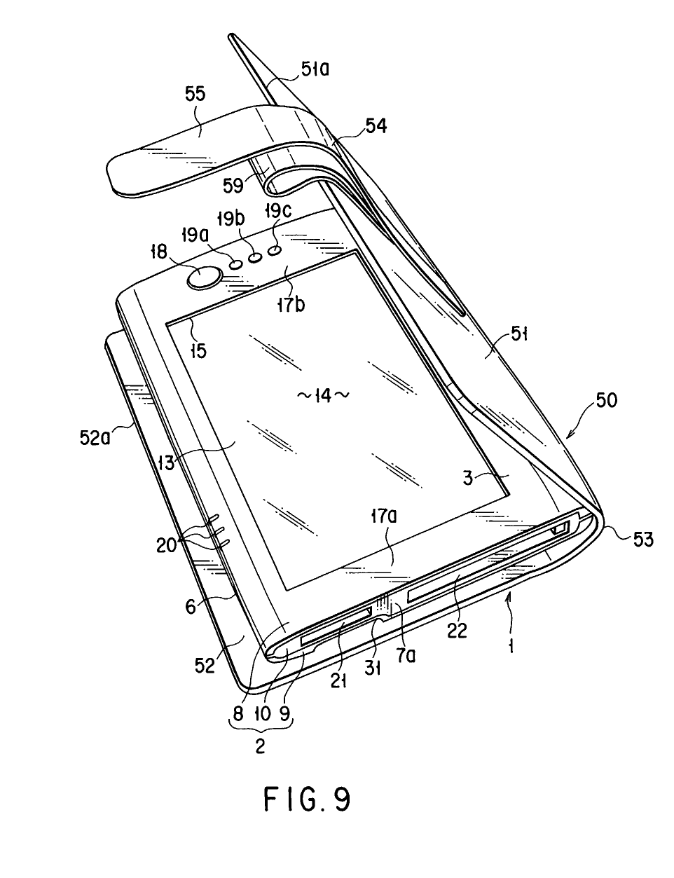

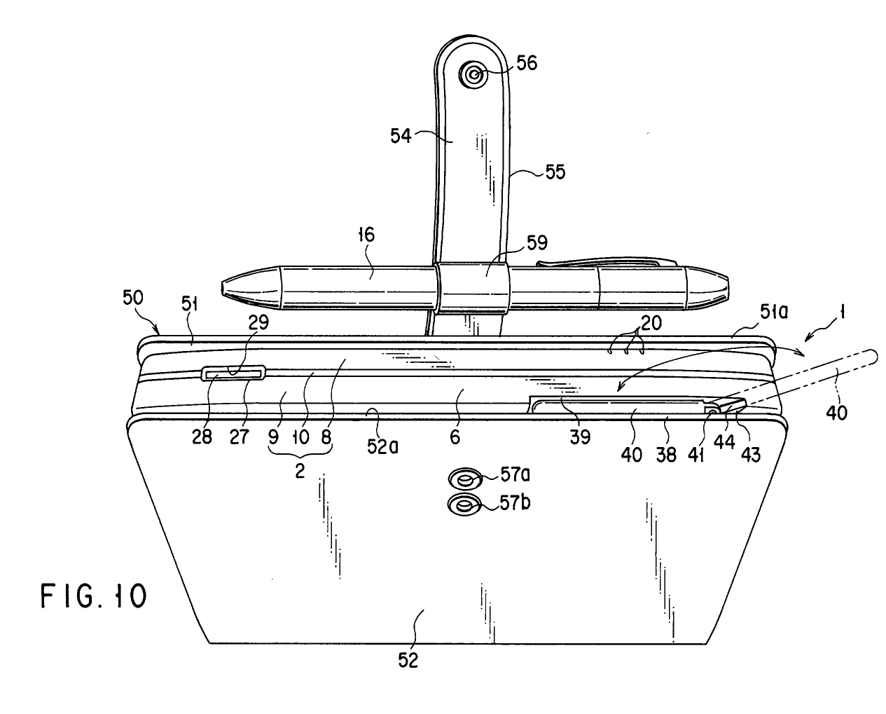

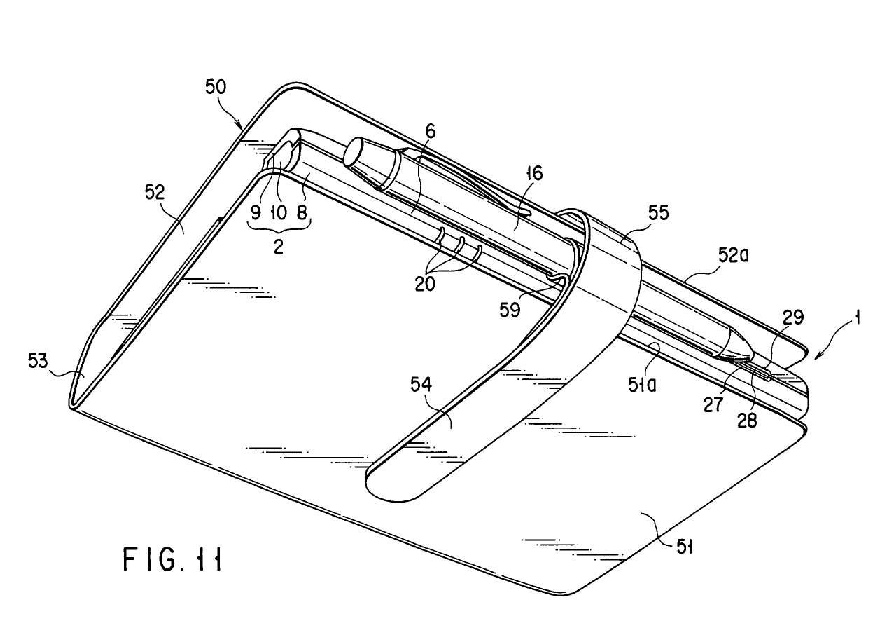

Firstly, the strap 54 is unfastened from the second cover section 52 and the first cover section 51 is removed from the top surface 3 of the main body 2. As a result, the top surface 3 of the main body 2 and the screen 14 are exposed to the outside as shown in FIGS. 9 and 12.

Then, a left end portion of the main body 2 is grasped by the left hand L while a right end portion of the main body 2 is grasped by the right hand R. At this time, the index finger I of the left hand L is moved around and gets to the bottom surface 4 of the main body 2. Then, the finger tip of the index finger I is inserted between the bottom surface 4 of the main body 2 and the second cover section 52 and led into the cavity 31. As a result, a central part of the finger tip of the index finger I is laid on the guide plate 36 of the finger print detection sensor 35. In one embodiment, the power supply switch 27 is arranged at a longitudinally lateral area on the right of the main body 2 and may be turned on with the right hand. The finger print detection sensor 35 optically detects the finger print of the finger tip and collates the detected finger print and the finger print registered in advance. If the two finger prints are found to agree with each other as a result of the collation, the electronic apparatus 1 is driven into a standby state.

Then, the rod-shaped antenna 40, which, in one embodiment, may be arranged at a longitudinally lateral area on the left of the main body 2, is pivoted from the first position to the second position and made to project outward from the main body 2. As a result, the electronic apparatus 1 becomes ready for operation.

As described in the above embodiment, the power supply switch 27 may be arranged at a right end part of the rear surface 6 of the main body 2 and the rod-shaped antenna 40 may be arranged at a left end part of the rear surface 6 of the main body 2. Therefore, the operator can concentrate on the operation of the left hand L for pivoting the rod-shaped antenna 40 in order to maximize the sensitivity of radio communication and also on the operation of the right hand R for turning on the power supply switch 27 when using the electronic apparatus 1 by gasping a left end portion and a right end portion of the main body 2. In other words, the operator can operate the rod-shaped antenna 40 and the power supply switch 27 simultaneously or one after the other, while holding the main body 2 with the left hand and the right hand. Thus, the rod-shaped antenna 40 and the power supply switch 27 can be operated more easily to make the electronic apparatus 1 easier to use.

Furthermore, as shown in the embodiment illustrated in FIG. 12, when the operator operates the electronic apparatus 1, holding the main body 2 with the left and right hands, he or she can easily get to the power supply switch 27 and the rod-shaped antenna 40 at the rear surface 6 of the main body 2. Therefore, the operator does not need to switch from one hand to the other for holding the main body 2 when he or she wants to operate the power supply switch 27 or the rod-shaped antenna 40. Thus, the electronic apparatus 1 shows an improved operability in this respect.

The operating member of an electronic apparatus according to embodiments of the invention is not limited to the power supply switch. It may alternatively be the cursor key of the apparatus. Additionally, the longitudinally separated locations of the operating member and rod-shaped antenna are not limited to the lateral areas of the main body on the rear surface. For example, they may alternatively be in the lateral areas of the main body at one of the surfaces of the main body that is selected from the top surface, the front surface, the rear surface and the left and right lateral surfaces. Furthermore, the positional relationship between the rod-shaped antenna and the operating member may be inverted from that of the above described embodiment and the operating member may be arranged on a longitudinally lateral area on the left of the main body while the rod-shaped antenna may be arranged on a longitudinally lateral area on the right of the main body.

Finally, an electronic apparatus according to embodiments of the invention is not limited to that of a pen input type. It may alternatively be an apparatus that is provided on the top surface thereof with a keyboard.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a main body having a top surface provided with a display screen, the main body having first and second longitudinally separated lateral areas;
at least an operating member to be manually operated, said operating member being arranged in said first lateral area; and
a rod-shaped antenna for radio communication arranged in said second lateral area, said rod-shaped antenna being adapted to pivot between a first position where the antenna extends along said main body and a second position where the antenna projects outward from said main body.

2. An electronic apparatus according to claim 1, wherein said main body has a rear surface extending in a longitudinal direction of the main body and said operating member is arranged along one of the longitudinally lateral end sections of said rear surface while said rod-shaped antenna is arranged along another longitudinally lateral end section of said rear surface.

3. An electronic apparatus according to claim 2, wherein said rear surface of said main body has a recess at one of the end sections thereof and said operating member has a push button exposed to the outside of said main body and arranged in said recess.

4. An electronic apparatus according to claim 1, wherein said main body includes an upper case having a top surface, a lower case arranged opposite to the upper case and a frame interposed between the upper case and the lower case, said upper case, said lower case and said frame being linked to each other by means of a plurality of screws.

5. An electronic apparatus comprising:
a main body, said main body having a bottom surface, a front surface, a rear surface, right and left lateral surfaces and a top surface provided with a display screen;
at least an operating member to be manually operated, said operating member being arranged on one longitudinally lateral end section of said rear surface; and
a rod-shaped antenna for radio communication arranged on another longitudinally lateral end section of said rear surface, said rod-shaped antenna being adapted to pivot between a first position where the antenna extends along said main body and a second position where the antenna projects outward from said main body.

6. An electronic apparatus according to claim 5, wherein said rear surface of said main body has a recess at one of the end sections thereof and said operating member has a push button exposed to the outside of said main body and arranged in said recess.

7. An electronic apparatus comprising:
a main body having a top surface and a bottom surface, a display screen being arranged on said top surface;
a rod-shaped antenna for radio communication arranged at one longitudinally lateral area of the main body, said rod-shaped antenna being adapted to pivot between a first position where the antenna extends along said main body and a second position where the antenna projects outward from said main body; and
a cover which covers said main body, said cover including a first cover section covering the top surface of said main body, a second cover section covering the bottom surface of said main body, a third cover section bridging said first cover section and said second cover section, and a strap adapted for separably linking said first cover section to said second cover section with said main body interposed between said first cover section and said second cover section, said strap being arranged on said first cover section at a side opposite to said third cover section and located such that when said first cover section and said second cover section are linked by said strap, said strap does not obstruct the antenna from pivoting between the first and second positions.

8. An electronic apparatus according to claim 7, wherein a rear surface carrying said rod-shaped antenna is arranged at a side opposite to a front surface, said rear surface and said front surface extending along the longitudinal direction of said main body, and wherein said third cover section of the cover is adapted to cover said front surface of said main body while said strap of the cover is adapted to bridge said rear surface.

9. An electronic apparatus according to claim 8, wherein said first and second cover sections have respective edges extending outward beyond said rear surface of said main body, and said rod-shaped antenna is located between said edges of said first and second cover sections.

10. An electronic apparatus according to claim 9, wherein said rod-shaped antenna is adapted to extend outward from the cover beyond said edges of said first and second cover sections when said rod-shaped antenna is pivoted to said second position.

11. An electronic apparatus comprising:
a main body having an antenna containing section arranged at one longitudinally lateral area;
a rod-shaped antenna for radio communication arranged in said antenna containing section, said rod-shaped antenna being adapted to pivot between a first position where the antenna is stored in said antenna containing section and a second position where the antenna projects outward from said antenna containing section of said main body; and
a stopper arranged at said antenna containing section, said stopper being adapted to abut the rod-shaped antenna pivoted to said second position and define a standing angle of said rod-shaped antenna relative to said main body.

12. An electronic apparatus according to claim 11, wherein said main body has a rear surface along the longitudinal direction thereof and said antenna containing section includes a groove formed in said rear surface, said rod-shaped antenna being stored in said groove and adapted to be pulled out from said groove.

13. An electronic apparatus according to claim 12, wherein said antenna containing section has a linking section adapted for linking said rod-shaped antenna to said antenna containing section, and wherein said stopper is located adjacent to the linking section and has a stopper surface for contacting said rod-shaped antenna, said stopper surface of said stopper being inclined relative to the rear surface of said main body.

14. An electronic apparatus comprising:
a main body having a top surface provided with a display screen and a bottom surface provided with a cavity adapted to receive a user's finger;
at least an operating member to be manually operated, said operating member being arranged at a first lateral area of said main body;
a rod-shaped antenna for radio communication arranged at a second lateral area of said main body, the second lateral area being longitudinally separated from the first lateral area, said rod-shaped antenna being adapted to pivot between a first position where the antenna extends along said main body and a second position where the antenna projects outward from said main body; and
a fingerprint detection sensor arranged in the cavity, said fingerprint detection sensor adapted for optically detecting a fingerprint on the received finger.

15. An electronic apparatus according to claim 14, wherein the cavity is adapted to receive a user's left index finger.
